(19) United States
(12) Patent Application Publication
(10) Pub. No.: US 2013/0180081 A1
(43) Pub. Date: Jul. 18, 2013

(54) OPENING DEVICE FOR A DOOR OF AN ARTICLE OF FURNITURE AND AN ASSEMBLY COMPRISING A HINGE AND THE OPENING DEVICE

(71) Applicant: Luciano Salice, Carimate (IT)

(72) Inventor: Luciano Salice, Carimate (IT)

(21) Appl. No.: 13/824,820

(22) PCT Filed: Jan. 11, 2012
(86) PCT No.: PCT/EP2012/050339

§ 371 Date: Mar. 18, 2013

(30) Foreign Application Priority Data
Jan. 24, 2011 (IT) MI2011A 000067

(51) Int. Cl. E05F 3/20

(52) U.S. Cl. CPC E05F 3/20
USPC 16/64

(57) ABSTRACT

An opening device for a door (16) of an article of furniture supported oscillatingly with respect to a body of the article of furniture by means of at least a hinge having elastic automatic closing means (14) comprises an expulsion organ (11) for the door (16) and a reloading mechanism of the expulsion organ (11), and is conformed such as to be applicable to a part from between the fixed part or the mobile part of the hinge, the reloading mechanism being operatively connected to one from between the expulsion organ and an element of the hinge which is mobile with respect to the reloading mechanism and being operatively and selectively connectable to another between the expulsion organ and the element of the hinge which is mobile with respect to the reloading mechanism during at least a part of the opening movement of the door (16) such as to cause a reloading movement of the expulsion organ (11).

The invention comprises an automatically-reloading opening device for oscillating doors of articles of furniture.

In the sector of furnishing, for reasons of design, the articles of furniture are often provided with oscillating doors lacking handles or like means for opening.

In this case, to open the door, suitable means or devices for opening must be provided, which, following a push on the closed door by the user, generate a displacement of the door in the opening direction by a first tract sufficient for the user then to grip it and completely open it.

In this ambit, it is advisable to provide an automatic reclosing of the door once it has been manually returned towards the closing position; however, this requirement is in contrast with the operating modality of the means or devices for opening of known type.

In a case in which the door is connected to the article of furniture by means of hinges with a spring acting during opening, generally known as a push spring, this solution involves the presence of a suitable ratchet device for blocking the door in the closing position, the opening means being constituted by the spring of the hinges; in this case, a reclosing device of the door, if present, should provide a closing force greater than that of the opening springs, thus making a subsequent opening of the door using the springs impossible.

In the case of hinges of traditional type, with a spring acting during closing, to open the door it is necessary to apply a separate opening device, which conventionally exhibits an elastically-stressed pusher which, having performed its action, needs to be reloaded via a push in the opposite direction on the pusher exerted by the door itself in the final tract of the closing movement of the door; in this case, since the thrust required for reloading the opening device is greater than the thrust provided by the spring of the hinge in the closing direction, a supplementary manual push is required for re-closing the door.

With the aim of obviating this problem, the use of opening devices of the door having been proposed, having an automatic reloading mechanism selectively engageable with the door such as to act during the manual opening thereof and thus cause reloading of the opening means, such as not to obstruct the successive closing action of the door exerted by the springs of the hinges.

However, the opening devices are extremely complicated and expensive, as the reloading mechanism comprises a plurality of elastic means and cursors which interact with each other in complex movements, or a suitable electric actuator, conformed and arranged such as to perform a recharging of the device.

Further, as these devices are conventionally applied to the article of furniture on an opposite side to the hinges, they exhibit drawbacks of an aesthetic character and various operations have to be performed, both on the article of furniture and on the door, such as to predispose the fixing and functioning thereof, apart from supplementary operations of mounting such as to apply the separate devices.

The main aim of the invention is to provide a device that can obviate the above-mentioned problems.

The aim of the invention is attained by an opening device for a door of an article of furniture supported oscillatingly with respect to the body of the article of furniture by means of at least a hinge having a fixed part, a mobile part and elastic automatic closing means, the device comprising an expulsion organ for the door and a reloading mechanism of the expulsion organ, characterised in that it is conformed such as to be applicable to or integratable in a part from between the fixed part or the mobile part of the hinge, and in that the reloading mechanism is operatively connected to one from between the expulsion organ and an element of the hinge which is mobile with respect to the reloading mechanism and is operatively and selectively connectable to another between the expulsion organ and the element of the hinge which is mobile with respect to the reloading mechanism during at least a part of the opening movement of the door such as to cause a reloading movement of the expulsion organ.

Said expulsion organ is preferably a part of an expulsion device of a ratchet type.

The present invention further relates to an assembly comprising a hinge of a type presenting a fixed part and a mobile part, connected to one another hingedly by means of at least a rocker, and the above-mentioned opening device. Said opening device is preferably applied to a leaf or to a base of said fixed part of the hinge.

Alternatively the opening device can be applied to the box, defining the mobile part of the hinge, in which the rocker is hinged.

Alternatively again, the opening device can be integrated in the leaf or in the box of the hinge.

In first preferred embodiment, the reloading mechanism comprises transmission means that are operatively connected to the rocker and are selectively engageable with the expulsion organ.

The transmission means preferably comprise an oscillating transmission element engaging with said rocker and an oscillating reloading organ engaging with said transmission element.

Said oscillating transmission element and said oscillating reloading organ are preferably pivoted to said fixed part of the hinge.

Said opening device preferably exhibits a longitudinal seating in which said expulsion organ is longitudinally slidable, said seating exhibiting at least an opening for the selective engagement of said reloading organ with at least a projecting wing of said expulsion organ.

Said expulsion organ is preferably selectively engageable against a part of said box of the mobile part of the hinge.

Said oscillating transmission element and said oscillating reloading organ exhibit a respective oscillation axis parallel to the hinge axis of the rocker to the box of said mobile part of the hinge.

In a second preferred embodiment of the invention, the reloading mechanism comprises a reloading cursor supported on one of the fixed or mobile parts of the hinge in a way which is mobile parallel to the expulsion organ and selectively engageable to the other part of the hinge.

The reloading mechanism preferably comprises, in this case, an oscillating transmission lever engaging on opposite sides to the oscillation fulcrum thereof respectively with said reloading cursor and with said expulsion organ. Said reloading cursor is preferably engageable in an opening of an edge of a box exhibited by said mobile part of hinge.

Further characteristics and advantages of the invention will better emerge from the description of preferred but not exclusive embodiments of the opening device for oscillating doors of an article of furniture according to the invention, illustrated by way of non-limiting example in the accompanying drawings, in which:

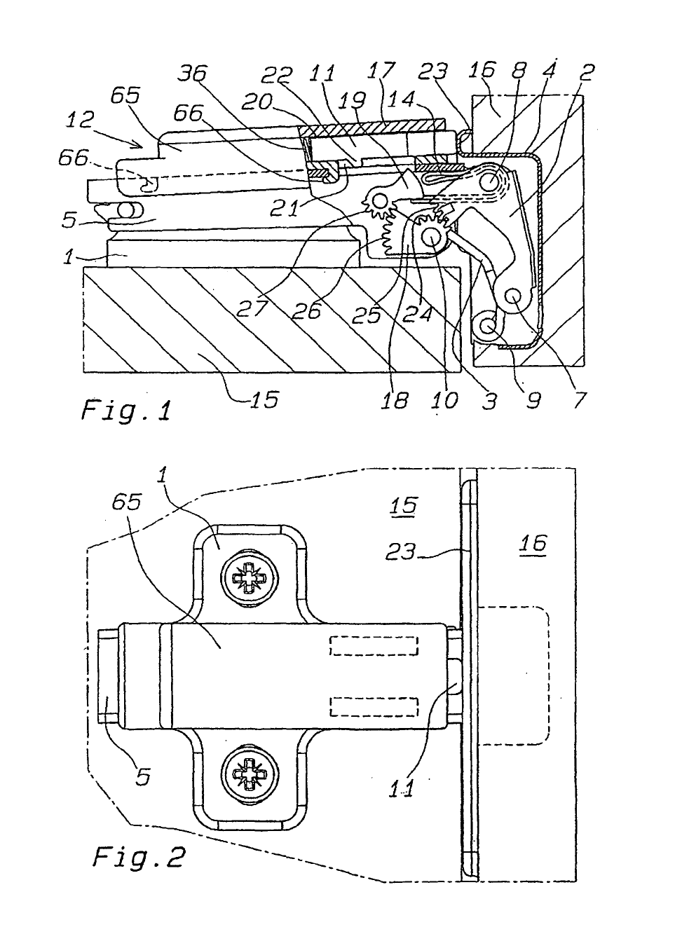

FIG. 1 is a lateral and partially sectioned view of an assembly comprising a hinge for an article of furniture, shown in the closing position of the oscillating door, and an opening device in a first preferred embodiment of the invention, shown in a blocked configuration of the expulsion organ;

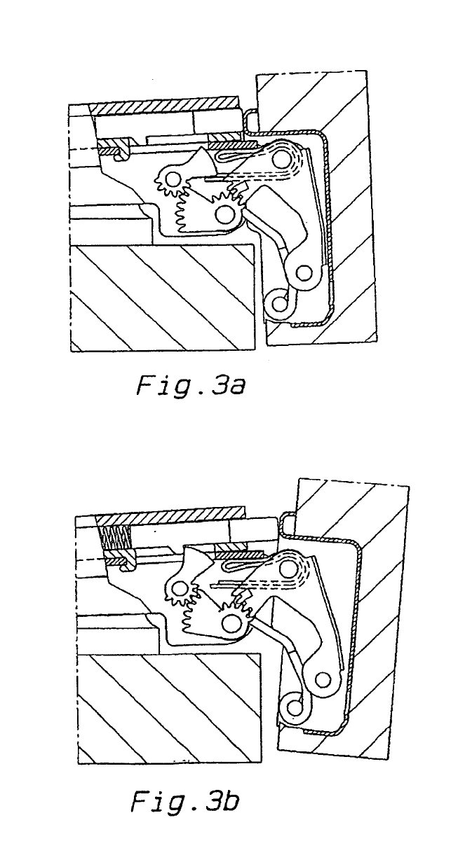

FIG. 2 is a plan view of the assembly of FIG. 1;

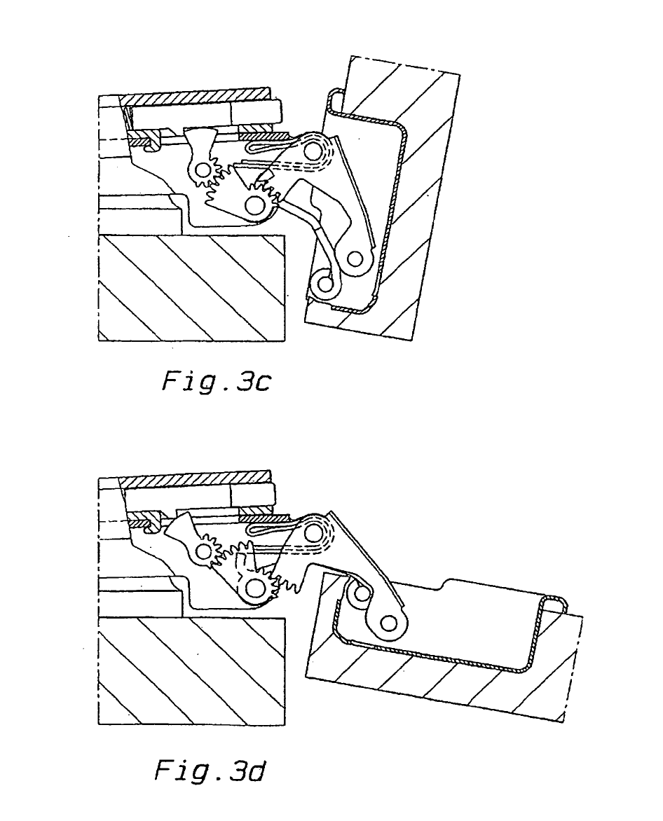

FIGS. 3a, 3b, 3c and 3d are lateral views of the sequence of the configurations taken on by the opening device during the opening of the oscillating door, with a first configuration corresponding to the unblocking of the expulsion organ (FIG. 3a) when the hinge is in the closing position of the oscillating door, a second configuration in which the expulsion organ performs the initial opening step of the oscillating door (FIG. 3b), a third configuration in which the reloading mechanism is engaged with the expulsion organ during a step of manual opening of the oscillating door (FIG. 3c), and a fourth configuration in which the reloading mechanism has reloaded the expulsion organ and the manual opening of the oscillating door proceeds up to complete opening thereof (FIG. 3d);

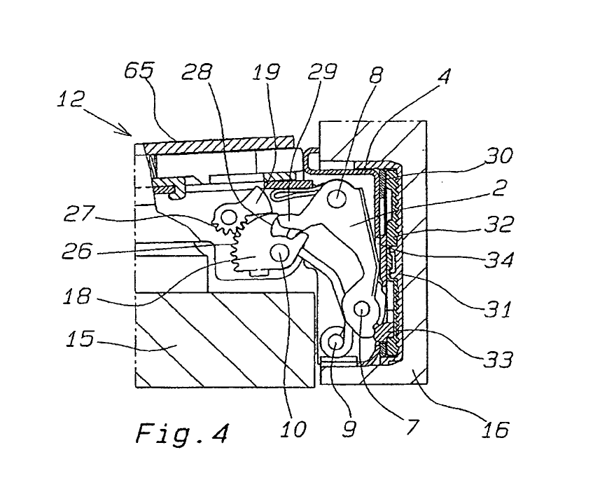

FIG. 4 is a lateral view, partially in section, of a variant of the assembly of FIG. 1, in which the hinge exhibits a device for slowing its closure down;

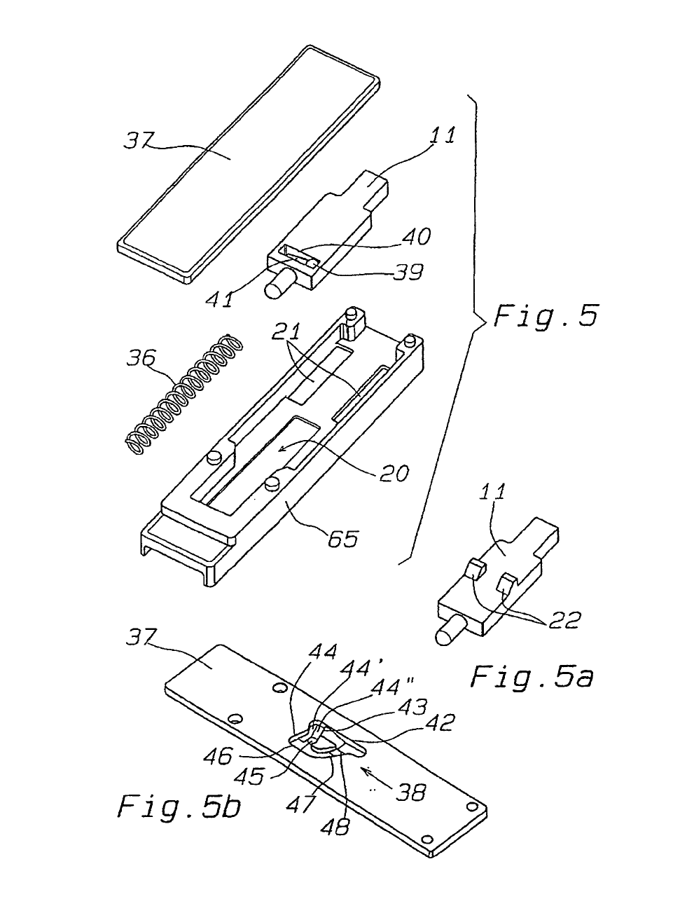

FIG. 5 is an exploded perspective view of the ratchet expulsion device in the assembly illustrated in FIGS. 1 and 4, which also exhibits a view of the expulsion organ (FIG. 5a) and the cover (FIG. 5b) in an upturned position;

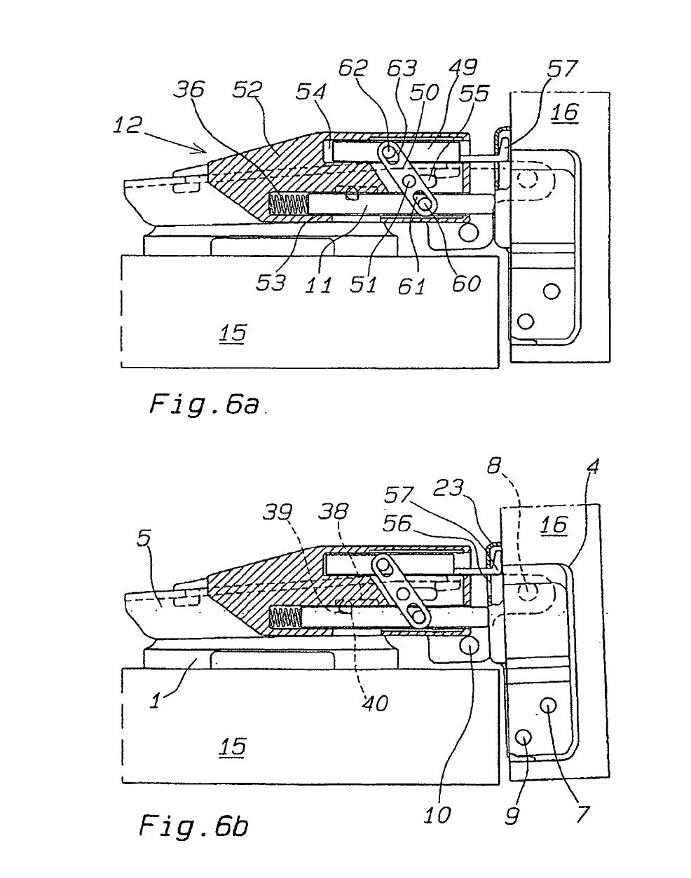

FIGS. 6a, 6b, 6c and 6d illustrate, in relation to an assembly comprising a hinge and an opening device of a second preferred embodiment of the invention, a partly-sectioned lateral view of the sequence of the configurations taken on during the opening of the oscillating door by the opening device, with a first configuration corresponding to the blocking of the expulsion organ (FIG. 6a), when the hinge is in the closing position of the oscillating door, a second configuration of unblocking of the expulsion organ (FIG. 6b), when the hinge is in the closing position of the oscillating organ, a third configuration in which the expulsion organ performs the initial step of opening the oscillating door (FIG. 6c), a fourth configuration in which the reloading mechanism has reloaded the expulsion organ during the step of manual opening of the oscillating door (FIG. 6d);

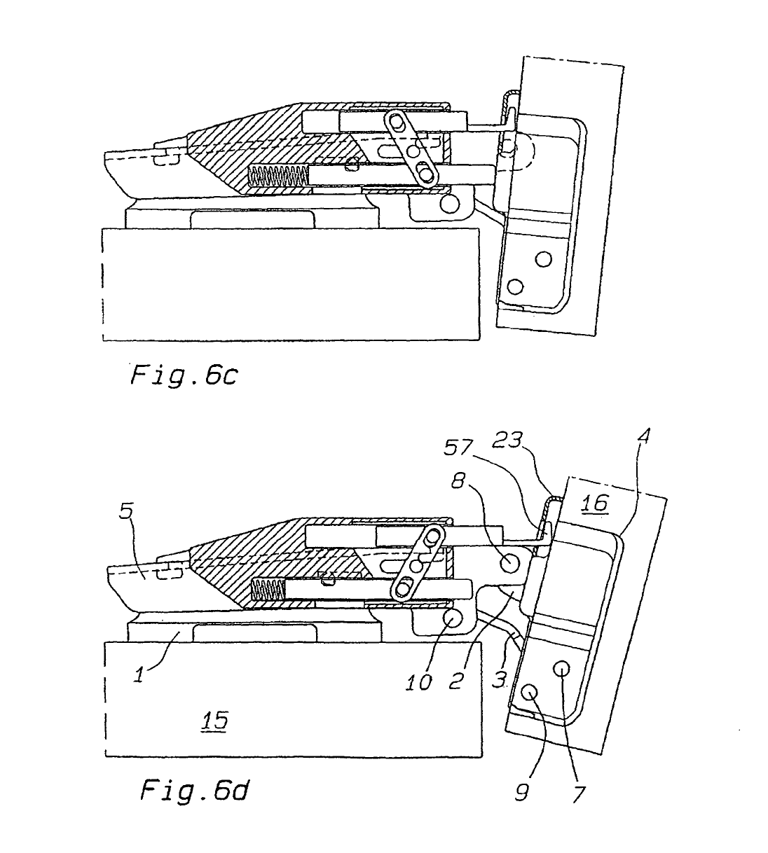

FIG. 7 is a plan view of the assembly of FIG. 6a;

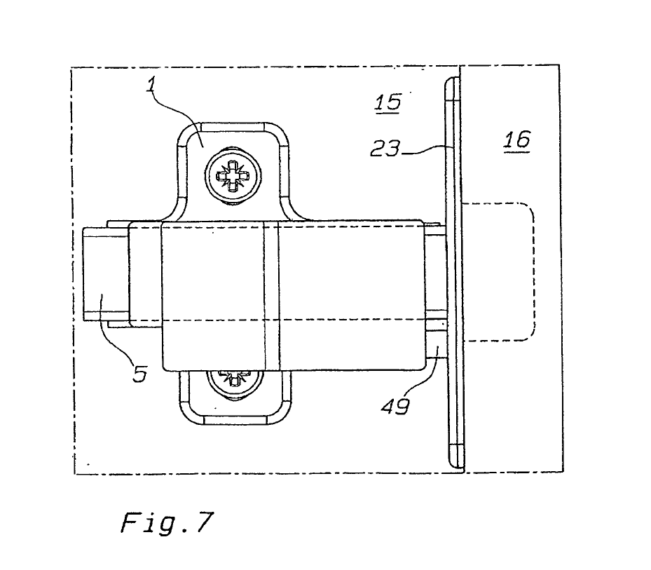

FIG. 8 shows a partially sectioned lateral view of a variant of the assembly of FIG. 6a, in which the opening device is applied not to the leaf but to the base of the fixed part of hinge; and

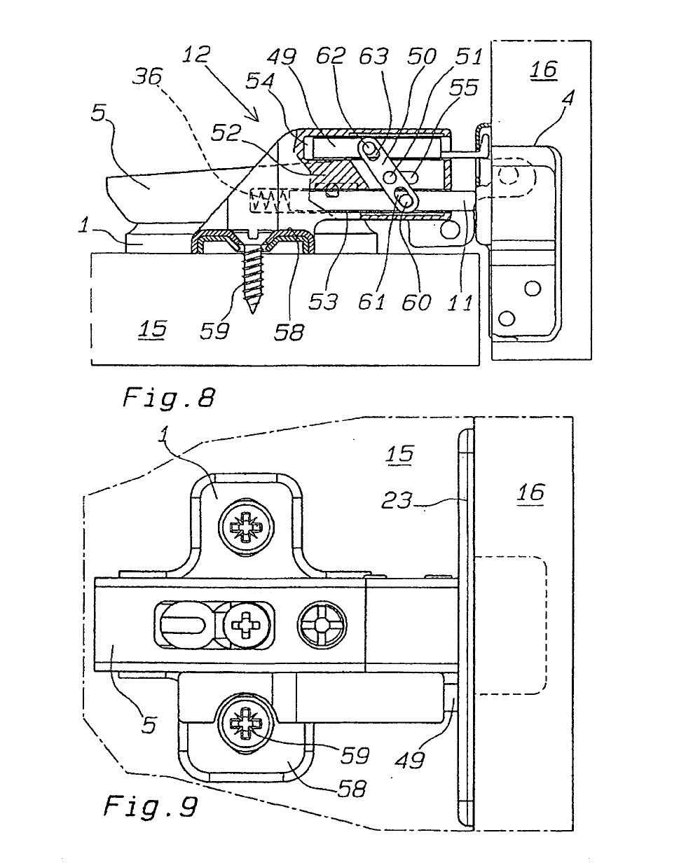

FIG. 9 is a plan view of the assembly of FIG. 8.

Equivalent parts of the various preferred embodiments of the invention will be denoted using the same numerical reference.

With reference to the mentioned figures, the hinge comprises a fixed part of hinge associable to a fixed body of an article of furniture and a mobile part of hinge associable to a displaceable element of an article of furniture, for example a door, and connected to the fixed part of hinge rotatingly between an opening position and a closing position of the displaceable element of the article of furniture.

The fixed part of hinge comprises a base 1 applied to a flank 15 of the article of furniture and a leaf 5 applied .to the base 1, while the mobile part of hinge comprises a box 4 applied to the oscillating door 16 of the article of furniture and connected to the leaf 5 by means of a first and a second rocker 2, 3.

An opening device for the door 16 is associated to the hinge, comprising an expulsion organ 11 for the door 16 and a reloading mechanism of the expulsion organ 11.

The opening device is advantageously conformed such as to be applicable or integrable in one of either the fixed or mobile part of the hinge.

The reloading mechanism is operatively connected to one between the expulsion organ and an element of the mobile hinge with respect to the reloading mechanism and operatively connectable selectively to the other of the expulsion organ and the element of the mobile hinge with respect to the mechanism such as to cause the reloading movement of the expulsion organ 11.

The expulsion organ 11 is present in an expulsion device 12 of the ratchet type applied to the leaf 5.

The first rocker 2 is pivoted with the pin 7 to the box 4 and the pin 8 to the front part of the leaf 5, while the second rocker 3 is pivoted with the pin 9 to the box 4 and the pin 10 to the front part of the leaf 5. The hinging pin 7, 8, 9, 10 exhibit parallel axes.

The hinge exhibits elastic means acting automatically to push the mobile part of the hinge towards the closing position of the door 16. In particular, the elastic means comprise a spring 14 wound about the hinging pin 8 of the first rocker 2 and having a spring arm engaged against the back 17 of the leaf 5 and a spring arm engaged against a cam in proximity of the end of the rocker 3 adjacent to the hinging pin 10.

Reference is now made to the versions of the opening device illustrated in figures from 1 to 5.

The reloading mechanism comprises transmission means operatively connected to the rocker 2 and selectively engageable with the expulsion organ 11.

The transmission means comprise an oscillating transmission element 18 engaging with the rocker 2 and an oscillating reloading organ 19 engaging with the transmission element 18.

The oscillating transmission element 18 and the oscillating reloading organ 19 are pivoted to the front part of the leaf 5 and the oscillation axis thereof is parallel to the hinge axes of the rockers 2 and 3.

In particular the transmission element 18 is supported oscillatingly by the hinging pin 10 of the rocker 3.

The expulsion device exhibits a body 65 applied to the leaf 5 in particular by means of engaging organs 66, and the body 65 in turn exhibits a longitudinal seating 20 in which the expulsion organ 11 is longitudinally slidable to engage selectively against the edge 23 of the box 4.

The sliding direction and incidence of the expulsion organ 11 against the edge 23 is preferably slightly inclined with respect to the flank 15 of the article of furniture. At least an opening 21 is present in the seating 20 for selectively engaging the reloading organ 19 with at least a projecting wing 22 of the expulsion organ 11.

In the version of the opening device of FIGS. 1-3d, the transmission element 18 comprises a first cogging 24 enmeshed with a cogging 25 afforded on the profiled end of the rocker 2 adjacent to the hinging pin 8, and a second cogging 26 enmeshing with a cogging 27 afforded on the reloading organ 19.

In the version of the opening device of FIG. 4, the transmission element 18 comprises a cam 28 engaged with a tooth 29 afforded on the profiled end of the rocker 2 adjacent to the hinging pin 8 and, like the previous version, a cogging 26 enmeshing with a cogging 27 afforded on the reloading organ 19.

In FIG. 4, the hinge is also of the type that exhibits an integrated decelerating device, of known type.

The decelerating device is applied to the external side of the bottom of the box 4 and comprises a container exhibiting a first part 30 and a second part 31 assembled to one another such as to close a friction disc 32 activatable in rotation by a cursor 33 moved by the end of the rocker 2 adjacent to the hinging pin 7, which exhibits a cam specially profiled such as to interact with the cursor 33 to which it has access via an opening 34 in the bottom of the box 4.

The structure of the ratchet expulsion device 12 in the versions of figures from 1 to 5 is of known type and comprises the body 65 in which both the seating 20, frontally open for exit of the thrust organ 11, which is mobile in contrast to and by action of a spring 36, and the opening 21 for access to the seating 20 are afforded. A covering element 37 of a side of the seating 20 is applied to the body 65. The covering element 37 exhibits, on the side thereof facing towards the seating 20, a track 38 having a variable depth along which a sphere 39 is mobile, which sphere 39 is positioned in a guide 40 afforded on the expulsion organ 11. The guide 40 enables the displacement of the sphere 39 on the expulsion organ 11 in a transversal direction to the sliding direction of the expulsion organ 11. A flat spring 41 in a V-shape is interposed between the bottom of the guide 40 and the sphere 39, which spring pushes the sphere 39 against the bottom of the track 38 in such a way as to cause it to follow the relative variable-depth pathway. The track 38 comprises a first tract 42 parallel to the translation direction of the expulsion organ 11 and exhibiting a bottom defining a ramp that terminates with a first step 43 that separates it from a second tract 44 that is transversal to the translation direction of the expulsion organ 1 and in turn exhibiting two sub-tracts 44′ and 44″ that are flanked and develop of staggered levels, in the deeper of which, adjacent to the first tract 42, a seating 45 is present having a complementary shape to that of the sphere 39. A third tract 46 of the track 38 following the second tract 44 is parallel to the translation direction of the expulsion organ 11, while a fourth tract 47 of the track 38, following the third tract 46, is transversal to translation direction of the expulsion organ 11 and exhibits a bottom defining a ramp that terminates with a second step 48 that separates it from the first tract 42.

The functioning of the opening device, with reference to the versions illustrated in FIGS. 1 to 5, is the following.

The door 16 is initially in the closed position, in which the sphere 39 is positioned in the seating 45 and blocks the expulsion organ 11. The user applies a slight push to close the door 16 for unblocking the expulsion organ 11. By effect of this slight push, the sphere 39 exits from the relative seating 45, and moves into the sub-tract 44′ that is less deep than the second tract of track 44. At this point the spring 41 pushes the sphere 39 towards the third tract of track 46, thus releasing the block on the expulsion organ 11 which is extracted from the seating 20 by effect of the force exerted by the spring 36 and begins to push against the edge 23 of the box 4.

The displacement of the expulsion organ 11 determines the initial tract of automatic opening of the door 16 which is then accompanied by the hand in order to complete the opening.

During the completion of the opening of the door 16 the rocker 2, when rotating (in the anti-clockwise direction of FIGS. 1-5) draws the transmission element 18 in rotation (in the clockwise direction in the figures) which in turn draws the reloading organ 19 in rotation (in anti-clockwise direction in the figures).

By effect of the rotation, the reloading organ 19 intercepts, with the rear profile thereof, the front profile of the wing 22 of the expulsion organ 11 (FIG. 3b) and, overcoming the reaction of the spring 36, pushes the expulsion organ 11 in retraction in the seating 20 up to newly bringing it into the blocking position (FIG. 3c).

The automatic closing of the door 16 is ensured by the spring 17 which is not obstructed in its action by the expulsion organ 11.

Reference is now made to the versions of the opening device illustrated in figures from 6a to 9.

The reloading mechanism comprises a reloading cursor 49 supported on one of the fixed or mobile parts of the hinge, mobile parallel to the expulsion organ 11 and selectively engageable with the other part of the hinge.

The reloading mechanism further comprises an oscillating transmission lever 50 engaging on opposite sides of the oscillating fulcrum 51 thereof respectively with the reloading cursor 49 and the expulsion organ 11.

In particular the opening device comprises a body 52 applied to the leaf 5 (FIGS. 6a-7) or to the base 1 (FIGS. 8 and 9) and exhibiting a frontally open longitudinal seating 53 in which the expulsion organ 11 is longitudinally slidable and a longitudinal seating 54 also frontally open in which the reloading cursor 49 is longitudinally slidable.

In the version of the opening device illustrated in FIGS. 8 and 9, the body 52 advantageously exhibits a lateral flange 58 having a complementary shape to the fixing portion of the base 1 at the flank 15 to which the lateral flange 58 couples such as to exploit the screw 59 with which the base 1 is fixed to the flank 15 in order to fix the body 52 to the base 1.

The expulsion organ 11 is located in such a position as to interfere with the edge 23 of the box 4.

The oscillating fulcrum 51 of the transmission lever 50 comprises an oscillating pin parallel to the hinging pins 7, 8, 9 and 10 of the rockers 2 and 3 and supported in a guide 55 afforded in the body 52 slidably in a parallel direction to the sliding direction of the expulsion organ 11 and the reloading cursor 49.

The coupling between an arm of the transmission lever 50 and the expulsion organ 11 is realised by a pin 60 slidably engaged in a slot 61, and between the opposite arm of the transmission lever 50 and the reloading cursor 49 by means of a pin 62 slidably engaged in a slot 63.

The reloading cursor 49 is trapped in an opening 56 of the edge 23 of the box 4.

In particular the bent head 57 of the reloading cursor 49 is confined in the space comprised between the internal side of the edge 23 of the box 4 and the internal wall of the door 16.

The releasable block of the expulsion organ 11 is realised with a ratchet device entirely similar to the one described herein above and will therefore not be newly described. The figures showing the ratchet device illustrate the sphere 39 positioned in the guide 40 and mobile along the tract 38 afforded directly on the body 52 and the spring 36 in contrast and by action of which the expulsion organ 11 is mobile.

The functioning of the opening device, with reference to the versions illustrated in FIGS. 6 to 9, is as follows.

The door 16 is initially in a closed position in which the expulsion organ 11 is blocked by the ratchet system (FIG. 6a).

The user applies a slight closing push on the door 16 for unblocking the expulsion organ 11 (FIG. 6b). By effect of this slight push, the ratchet device unblocks the expulsion organ 11 which exits from the seating 20 by effect of the force exerted by the spring 36 and begins to push against the edge 23 of the box 4 (FIG. 6c).

The displacement of the expulsion organ 11 determines the initial automatic opening tract of the door 16 which is then accompanied by hand in order to complete the opening.

During the completion of the opening of the door 16 the edge 23 of the box 4 draws the cursor 49 which is extracted from the seating 54, forcing the expulsion organ 11 to effect a translation in the opposite direction, by effect of the transmission of movement determined by the transmission lever 50.

The expulsion organ 11 is retracted into the seating 53, overcoming the reaction of the spring 36, up to reaching the blocking position by action of the ratchet device (FIG. 6d).

The automatic closing of the door 16 is guaranteed by the spring 17 which is not obstructed, in its action, by the expulsion organ 11.

The automatic opening device is simple, effective, compact, has an extremely small visual impact and requires few and easy operations for mounting thereof on the hinge without need for interventions on the fixed and movable parts of the article of furniture.

The invention is susceptible to various modifications and variants, all falling within the ambit of the claimed concept. In particular, the opening device can be integrated in the leaf or box, with an appropriate sizing and conforming of the various parts.

In practice the materials used, as well as the dimensions, can be any according to needs or the state of the art.

Further, also possible is that at least a hinge provided with the opening device but not equipped with the decelerating device can be applied to a door of the article of furniture, and at least a hinge provided with the decelerating device, but without the opening device of the invention.

1. An opening device for a door of an article of furniture supported oscillatingly with respect to the body of the article of furniture by means of at least a hinge having a fixed part, a mobile part and elastic automatic closing means, the device comprising an expulsion organ for the door and a reloading mechanism of the expulsion organ configured to be applicable to or integratable in one of either the fixed part or the mobile part of the hinge, and the reloading mechanism is operatively connected to one of either the expulsion organ and an element of the hinge which is mobile with respect to the reloading mechanism and is operatively connectable selectively to the other of the expulsion organ and the element of the hinge which is mobile with respect to the reloading mechanism during at least a part of the opening movement of the door such as to cause a reloading movement of the expulsion organ.

2. The opening device for a door of an article of furniture according to claim 1, wherein said expulsion organ is a part of an expulsion device of a ratchet type.

3. An assembly comprising a hinge of a type exhibiting a fixed part and a mobile part hingedly connected to one another by means of at least a rocker (2), and an opening device according to claim 1.

4. The assembly according to claim 3, wherein said hinge has a decelerating device for use in closing movement of the door.

5. The assembly according to claim 3, wherein said opening device is applied to a leaf or to a base of the fixed part of the hinge.

6. The assembly according to claim 5, wherein the reloading mechanism comprises transmission means operatively connected to the rocker and selectively engageable with the expulsion organ.

7. The assembly according to claim 6, wherein said transmission means comprise an oscillating transmission element engaging with said rocker and an oscillating reloading organ engaging with said oscillating transmission element.

8. The assembly according to claim 7, wherein said oscillating transmission element and said oscillating reloading organ are pivoted to said leaf exhibited by said fixed part of the hinge.

9. The assembly according to claim 3, wherein said expulsion device exhibits a longitudinal seating in which said expulsion organ is longitudinally slidable, said seating exhibiting at least an opening for selectively engaging said reloading organ with at least a projecting wing of said expulsion organ.

10. The assembly according to claim 3, wherein said expulsion organ is selectively engageable against an edge of a box of said mobile part of the hinge.

11. The assembly according to claim 7, wherein said oscillating transmission element and said oscillating reloading organ exhibit a respective oscillation axis parallel to the hinge axes of the rocker to said fixed part and mobile part of the hinge.

12. The assembly according to claim 3, wherein the reloading mechanism comprises a reloading cursor supported on one of the fixed part or the mobile part of the hinge in a way which is mobile parallel to the expulsion organ and selectively engageable with the other part of the hinge.

13. The assembly according to claim 12, wherein said reloading mechanism comprises an oscillating transmission lever engaging on opposite sides to the oscillation fulcrum thereof respectively with said reloading cursor and with said expulsion organ.

14. The assembly according to claim 12, wherein said reloading cursor is engageable in an opening of an edge of a box exhibited by the mobile part of hinge.

15. The assembly according to claim 3, wherein said opening device is integrated in a leaf of the fixed part of the hinge or in a box of the mobile part of the hinge.

16. An article of furniture comprising at least an assembly as in claim 3.

17. The article of furniture according to claim 16, further comprising at least a hinge provided with a deceleration device, but lacking the opening device.
